(19) United States
(12) Patent Application Publication
(10) Pub. No.: US 2025/0183630 A1
(43) Pub. Date: Jun. 5, 2025

(54) METAL TO METAL ENCAPSULATED ELECTRICAL POWER CABLE SYSTEM FOR ESP AND OTHER APPLICATIONS

(71) Applicant: BIM2M-ESP LIMITED [GB], Glasgow (GB)

(72) Inventor: Philip HEAD, Berkshire (GB)

(21) Appl. No.: 18/293,509

(22) PCT Filed: Jul. 28, 2022
(86) PCT No.: PCT/GB2022/052004

§ 371 Date: Jan. 30, 2024

(30) Foreign Application Priority Data
Jul. 29, 2021 (GB) 2110900.4

(51) Int. Cl. H02G 1/00; E21B 17/02; E21B 43/12; H02G 1/14; H02G 9/06; H02G 15/013; H02G 15/04

(52) U.S. Cl. CPC H02G 1/005; E21B 17/023; E21B 43/128; H02G 1/14; H02G 9/06; H02G 15/013; H02G 15/04

(57) ABSTRACT

A cable splice between a first electrical cable and a second first electrical cable together in a downhole environment, the first electrical cable including at least a first conductor, the second electrical cable including at least a second conductor bringing the first conductor into electrical contact with the second conductor forming a closed chamber around the first electrical cable and a second first electrical cable melting a low temperature metal or metal alloy and encapsulating the first electrical cable and a second first electrical cable in the penetrator body this metal or metal alloy.

An Electrical Submersible Pumping (ESP) system is an artificial-lift system that utilizes a downhole pumping system that is electrically driven.

The pump typically comprises several staged centrifugal pump sections that can be specifically configured to suit the production and wellbore characteristics of a given application.

Electrical submersible pump systems are a common artificial-lift method, providing flexibility over a range of sizes and output flow capacities.

A particular weakness of existing systems is that the power cable has to pass through several barriers, which results in a bulkhead and connectors which are either side of the bulkhead.

The barrier could be the wellhead, a downhole packer or the connection to the motor itself commonly called the pot head, it could also include changing from a round cable to a flat cable called a motor lead extension.

Inside an oil well, the pressures and temperatures can be very high, in addition, gases are vented and can penetrate the jacket of the power cable and migrate to the connector itself.

Saudi Aramco have identified for them that they can attribute 69% of there failures to the power cable system. (Ref: SAUDI ARAMCO JOURNAL OF TECHNOLOGY FALL 2016)

It is the purpose of the present invention to improve the electrical connection provided to downhole pumps and other downhole devices.

Providing pre-assembled cable assemblies that comprise a penetrator body with the cable encapsulated in a low temperature alloy such as bismuth, allows the elimination of electrical connectors at bulk heads or other barriers which a cable has to pass through in order to supply a pump or other similar downhole device.

According to the present invention there is provided a method of joining a first and second cable according to claim 1. According to another aspect of the present invention there is provided a cable splice formed by such a method.

According to a further aspect of the invention the pot head is encapsulated in a low temperature alloy such as bismuth and includes an electric heating element which creates a metal-to-metal seal the housing of the motor.

According to a further aspect of the invention, a heater is provided in an external assembly to heat the splice housing in a controlled way to ensure when filled with molten bismuth, the molten bismuth does not prematurely solidify.

According to a further aspect of the invention, a temperature sensor is part of the assembly and is recorded to a data logger.

According to a further aspect of the invention, end fittings seal the splice tube and seal around the cable.

According to a further aspect of the invention, a removable mould can fit around the splice and cable, into which the molten bismuth is cast, when solidified the mould can be removed, this would eliminate end fittings and the splice tube.

According to a further aspect of the invention, the molten bismuth filling system is a closed system and cannot spill.

According to a further aspect of the invention, a pressure test port can be included into the penetrator to confirm the integrity of the metal-to-metal seal when assembled into the motor

According to a further aspect of the invention the bismuth seals around the cable armour.

According to a further aspect of the invention the bismuth seals around the cable jacket.

According to a further aspect of the invention the bismuth seals around the lead jacket of each conductor.

According to a further aspect of the invention the bismuth seals around the individual cable conductors.

According to a further aspect of the invention the bismuth can be remelted to enable disassembly.

According to a further aspect of the invention the splice can be covered in a insulation boot, eliminating traditional tape and saving considerable time

According to a further aspect of the invention a drain port is provided to enable the bismuth to be emptied from the chamber.

According to a further aspect of the invention, different melting points of bismuth alloys can be selected depending on the anticipated well bore temperature.

According to a further aspect of the invention different alloys can be selected to have different melting points

According to a further aspect of the invention lead can be used as the encapsulant for applications above 270 C. which is the melting point of pure bismuth

The following is a more detailed description of an embodiment according to the invention by reference to the following drawings in which:

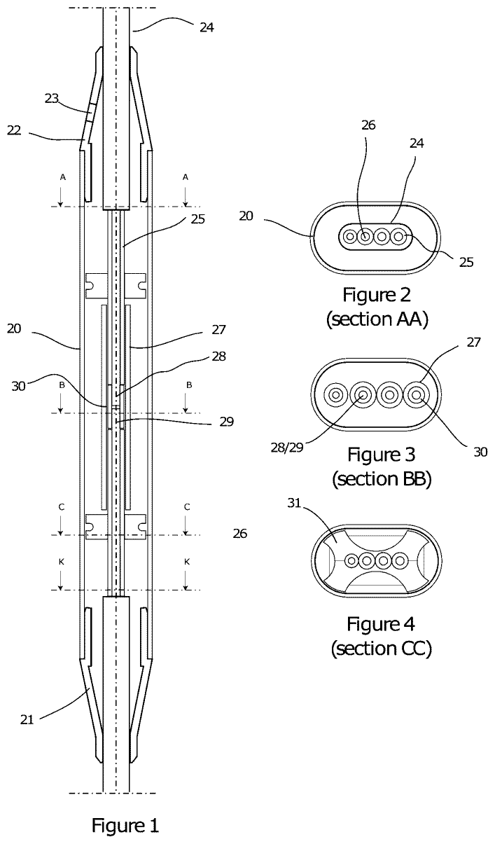

FIG. 1 is a section side view of a splice inside a housing and encapsulated in bismuth

FIG. 2 is a section end view AA of FIG. 1

FIG. 3 is a section end view BB of FIG. 1

FIG. 4 is a section end view CC of FIG. 1

FIG. 5 is a section side view of a splice inside a removable mould and encapsulated in bismuth

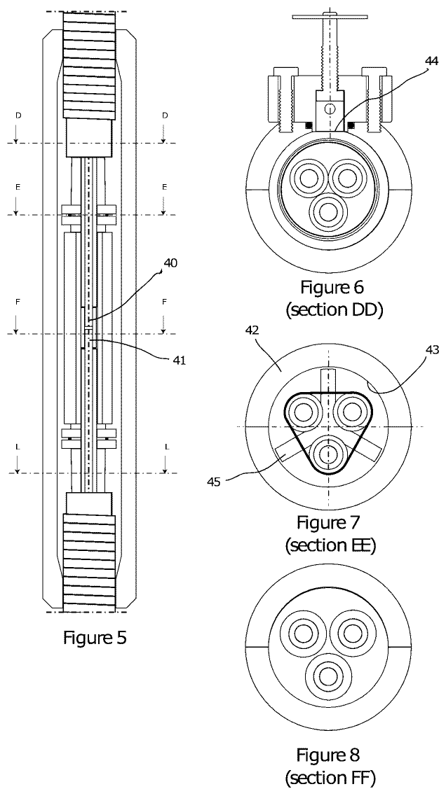

FIG. 6 is a section end view DD of FIG. 5

FIG. 7 is a section end view EE of FIG. 5

FIG. 8 is a section end view FF of FIG. 5

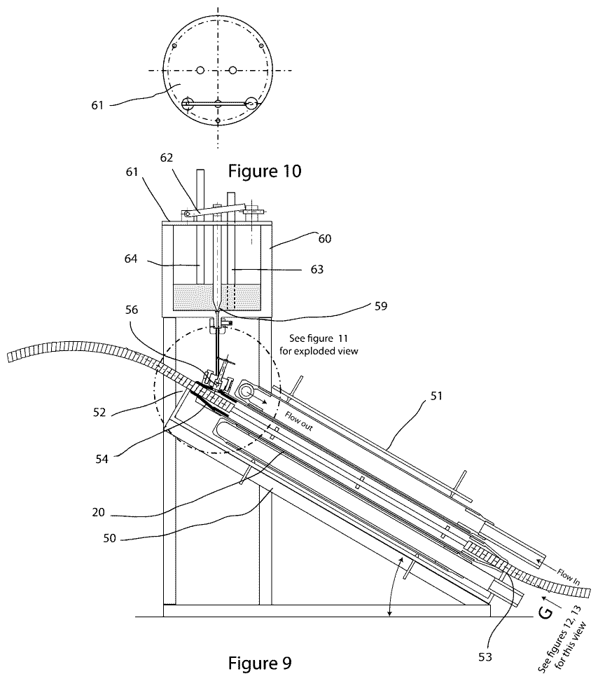

FIG. 9 is a section side view of the molten bismuth filling apparatus

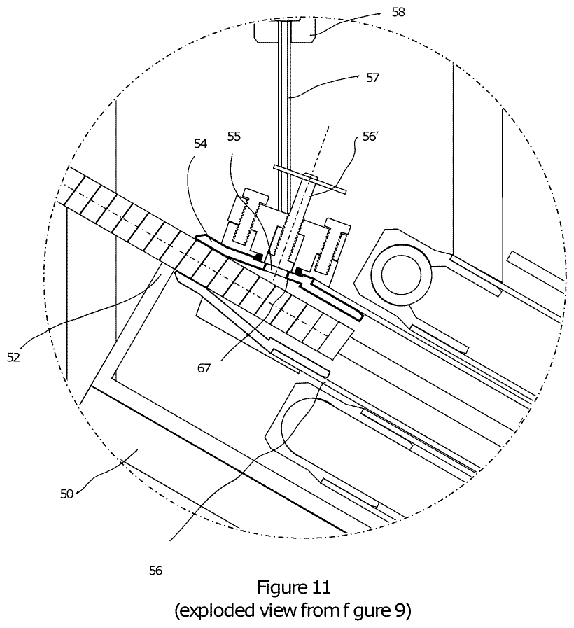

FIG. 10 is a plan view of the lid of the furnace

FIG. 11 is an exploded view of a detail in FIG. 9

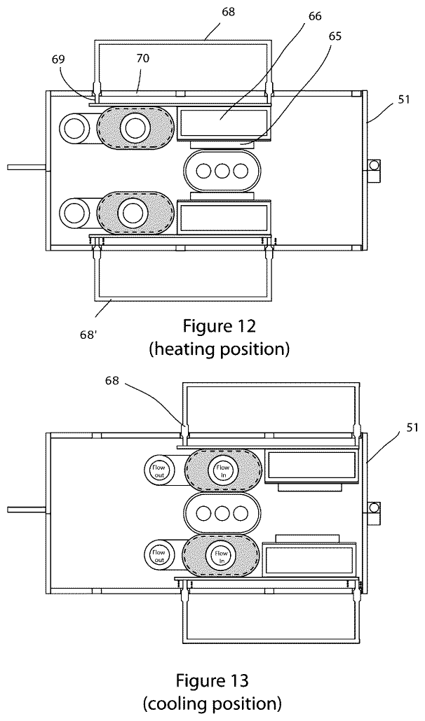

FIG. 12 is a section end view in the direction of arrow G of FIG. 9, in a heating position

FIG. 13 is a section end view in the direction of arrow G of FIG. 9, in a cooling position

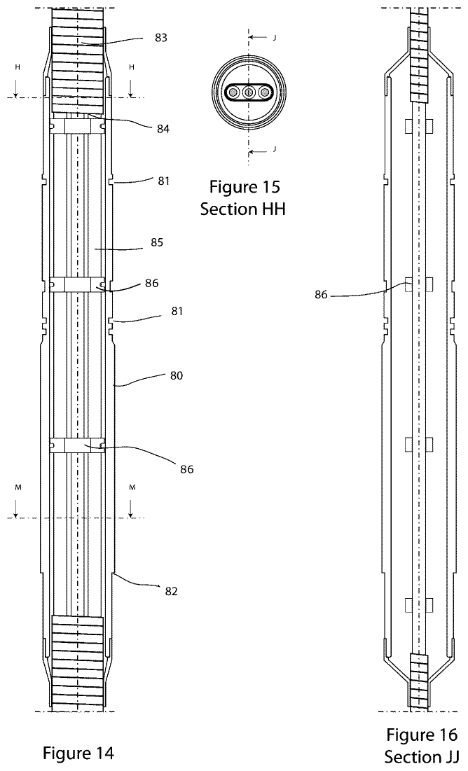

FIG. 14 is a section side view of a packer or wellhead penetrator.

FIG. 15 is a section end view HH of FIG. 14

FIG. 16 is a section side view JJ of FIG. 15

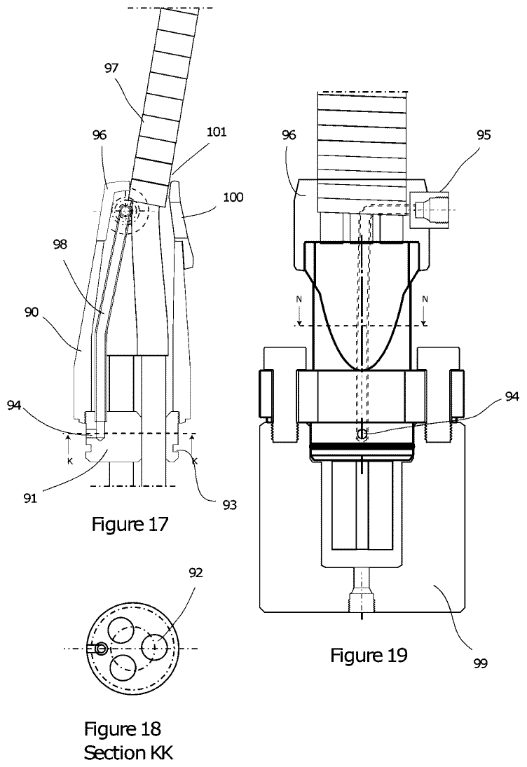

FIG. 17 is a section side view of a motor penetrator, typically called a pot head, as traditionally it was potted with a resin

FIG. 18 is a section end view KK of FIG. 17

FIG. 19 is a partial section side view of the cables being pressure tested

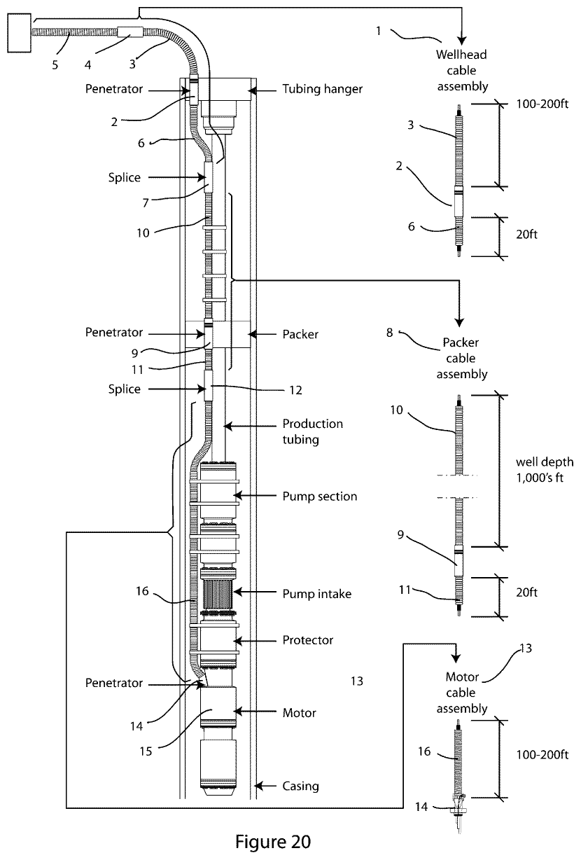

FIG. 20 is an illustration of an ESP in a well, with the three factory cable assemblies identified and which are spliced together

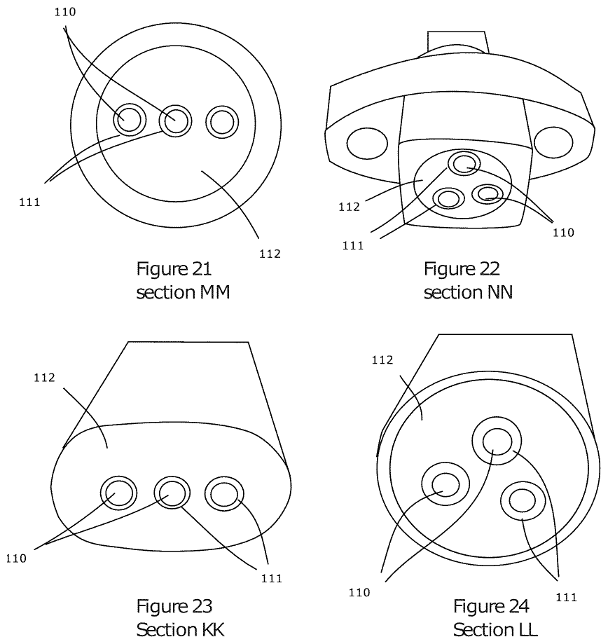

FIG. 21 is a section end view MM of a packer or wellhead penetrator

FIG. 22 is a section end view NN of a motor penetrator

FIG. 23 is a section end view KK of a splice in an oval tube

FIG. 24 is a section end view LL of a splice in a round tube

Referring to FIGS. 1 to 4 there is shown an embodiment of the invention in the form of a splice tube 20, a lower end fitting 21 and an upper end fitting 22. The upper end fitting has a port 23 which is used to fill the void spaces inside the tube with molten bismuth alloy as will be described further below.

The power cable shown here in the process of being spliced consists of an outer jacket 24, insulation 25 around the conductor and the copper conductor 26 itself. A sufficient length of jacket 24 is removed to enable splice insulation sleeve 27 to be fitted and ready to cover the slice. The two copper ends 28,29 of an individual conductor are fitted into a nickel press sleeve 30, and crimped together using a suitable crimping tool, and any sharp edges are sanded smooth. The insulation sleeve can then be slide over the nickel press sleeve and also have a substantial overlap with the conductor insulation 25 and each side of the nickel press sleeve.

Centralisers 31 are positioned both sides of the splice to keep the exactly in the centre of the tube. Prior to the splice operation, the lower end fitting 21 and splice tube 20 are slid over the lower power cable jacket 24 and the upper end fitting 22 is pre-installed on the upper power cable jacket.

Once all four cables have been spliced and the centralisers fitted, the splice tube can be slide over the splice, and the end fitting installed into each end of the tube, and the assembly is now ready to be filled with molten bismuth alloy. This is shown in more detail FIG. 9 to FIG. 13. The cable shown here is of four core construction, though it will be appreciated that three core or other configurations could be treated using a similar method.

Referring to FIGS. 5 to 8 there is shown another embodiment of the invention. In this the conductor cable is a round three phase cable comprising three individual conductors 46 and includes a metal wrap armour 47 for additional mechanical protection.

The two cable ends 40,41 of an individual conductor to be spliced are prepared and joined in the same way as the embodiment shown in FIGS. 1 to 4. A slightly different centraliser 45 having three equally spaced radially extending legs is used in the case to centralise the cables both from each other and away from the mould 42 inner wall 43. When all three cables have been spliced, and centralisers fitted, a split mould 42 can be clamped centrally over the splice. As shown in section DD it has a filling port 44 and the filling operation will be described by FIGS. 9 to 13.

One advantage of this method is the cost saving of the outer tube and end fittings; however, an advantage of the outer tube and end fittings is that it has more robust end assemblies and can resist impact loads better.

FIGS. 9 to 13 show the molten bismuth filling assembly. The assembly consists of a frame 50 into which is mounted a clam shell heating and cooling circuit 51. At each end of the clam shell is a saddle 52,53 which constrains and locates the splice tube 20. The upper end fitting 54 has a fill port 55 which is on the upper side and end of the tube. A valve assembly 56 is clamped over the fil port 55, this is connected via a tube 57 to the discharge port 58 of the furnace, which has a bottom discharge valve 59. The furnace 60 is filled with the required volume of bismuth alloy beads while cold, the lid 61 is then fitted to ensure no molten bismuth can be spilled. A valve lever 62 is then fitted. A temperature gauge can be used to monitor the temperature inside the furnace, in addition two physical indicators provide secondary confirmation. A heavy rod 63 extends into the furnace and is joined to the top of the furnace by a pivot, such that when the bismuth alloy Is melted the rod sinks to the bottom of the furnace to provide a visual confirmation that the bismuth alloy is molten. A second rod 64 which is buoyant and free to slide downwards visually indicates the furnace emptying.

Inside the clam shell there is a heating circuit consisting of PTC fixed temperature heating elements 65 attached to or around a chamber or space 66, the wires from the heating elements being collected together so all the heating elements have a common plus and minus electrical connections. The heating elements are configured such that when power is applied they will reach a maximum temperature of e.g. 150 C., to heat the outer housing to ensure a good bond to the molten bismuth.

The valve lever 62 is lifted up and molten bismuth alloy flows down the tube, through the valve 56, and fills all the void space around the splice and to the inner surface of the tube and end fittings. Once full, the valve 56 can be closed 56′. This has a positive stop onto the boss face 67. The cooling circuit is then placed onto the splice tube. This is done on the upper side by lifting the cradle hands 68 up until the smaller diameter 69 is in line with the slot 70, the cradle can then be slid into its 2^{nd} position and lowered to contact the splice tube. Cold water is circulated to cool the splice tube. This operation is repeated on the low side with cradle hands 68′.

A cooling gel pack is placed around the valve 56 and the supply tube 57. Once the bismuth allow around the splice is cooled the valve 56 can be removed from the end fitting and serviced at a later date. The heating and cooling clam shell can be opened, and the finished splice extracted.

Referring to FIGS. 14 to 16 there is shown a packer or wellhead penetrator 80, this differs from the splice tube described previously in that it is a thick wall tube and has O ring grooves 81, and shoulders 82 for it to positively located into its respective bore (not shown). The armour 83 and jacket 84 are removed and the lead layer 85 in exposed. Centraliser 86 similar to those described in FIG. 1-4 are fitted around the lead layer of the conductors, and then the whole assembly can be filled with molten bismuth

Referring to FIGS. 17 to 19 there is shown the motor penetrator. This consists of a standard pot head body 90, a short-threaded extension 91 is fitted at its lower end, this has three holes 92 for the conductors to pass through, an O ring groove 93 is included and a pressure port 94 so that when installed into the motor the face seal between the motor and pot head body can be pressure tested. The pressure test fitting 95 is mounted in a upper end fitting 96 which also provides a good seal 101 around the cable 97 and includes a filling port 100. A small stainless-steel tube 98 connects the pressure test fitting 95 to the pressure test port 94. Once assembled the internal void space can be filled with molten bismuth, this is done at the factory. A housing 99 can be clamped to the lower surface of the pot head and pressure tested to ensure the integrity of the three conductors

Referring to FIG. 20, this is a section side view of a well with an ESP assembly installed on tubing, and three cable assemblies identified.

The wellhead cable assembly 1, has a wellhead penetrator body 2 encapsulated onto the power cable and an upper pig tail 3 being spliced 4 to the surface cable 5. The lower pig tail 6 is located inside the well and is field spliced 7 to the upper pig tail 10 of the packer cable assembly 8.

The packer cable assembly 8 has a packer penetrator body 9 encapsulated onto the power cable and an upper pig tail 10 being spliced 7 to the wellhead surface cable 6. The lower pig tail 11 is below the packer and is field spliced 12 to the pot head cable assembly 13.

The pot head cable assembly consists of metal encapsulated pot head 14, which terminates into to the motor 15, and has an upper pig tail 16 commonly called the motor lead extension, this is spliced 12 to the lower pig tail 11 of the packer cable assembly 8.

Referring to FIGS. 21 to 24 there is shown actual section view through each of the major components, i.e., the motor penetrator in FIG. 21, the packer and wellhead penetrator in FIG. 22, and a flat cable splice in FIG. 23 and the round cable splice in FIG. 24. In each example the cable 110 has a lead sheath 111, and the bismuth 112 is encapsulated around the lead sheath. The bond between the lead and the bismuth is such that it is impossible to see the lead-bismuth interface.

What is achieved by this invention is a metal encapsulated insulated electrical conductor from surface to the motor, with no reliance on elastomer O rings

In addition, the splice is achieved in minutes, whereas traditional splices can take up to three hours. In the context of an offshore rig, saving 6 hrs rig time could be equivalent to $50,000-$100,000

1. A method of forming a cable splice between a first electrical cable and a second first electrical cable together in a downhole environment, the first electrical cable including at least a first conductor, the second electrical cable including at least a second conductor, the method comprising:
bringing the first conductor into electrical contact with the second conductor;
forming a closed chamber around the first electrical cable and a second first electrical cable; and
melting a low temperature metal or metal alloy and encapsulating the first electrical cable and a second first electrical cable in the penetrator body this metal or metal alloy.

2. The method according to claim 1, comprising forming the closed chamber by a penetrator body around the first electrical cable and a second first electrical cable.

3. The method according to claim 2, comprising forming the closed chamber by the housing of the motor.

4. The method according to claim 3, comprising forming a metal to metal seal is formed with the housing of the motor.

5. The method according to claim 1, wherein the cable splice is passed through a bulk head, pothead or other barrier to supply a pump or other similar downhole device.

6. The method according to claim 1, comprising using an electric heating element to melt the metal or metal alloy.

7. The method according to claim 6, wherein the electric heating element is provided in an external assembly to heat a splice housing in a controlled way to ensure the metal or alloy does not prematurely solidify.

8. The method according to claim 1, wherein a temperature sensor is included and temperature data recorded to a data logger.

9. The method according to claim 1, wherein the closed chamber is a tube having end fittings seal the tube and seal around the cable splice.

9. The method according to claim 1, wherein the closed chamber is a removable mould can fit around the splice and cable

10. The method according to claim 1, wherein a pressure test port is included into the closed chamber to confirm the integrity of the encapsulation of the cable splice

11. The method according to claim 1, wherein a pressure test port is included into the penetrator to confirm the integrity of the metal-to-metal seal when assembled into the motor

12. The method according to claim 1, wherein the first and second cables include cable armour, and the metal or alloy seals around the cable armour.

13. The method according to claim 1, wherein the first and second cables include a cable jacket, and the metal or alloy seals around the cable jacket.

14. The method according to claim 1, wherein the first and second cables include a lead jacket, and the metal or alloy seals around the lead jacket of each conductor.

15. The method according to claim 1, wherein the first and second cables include a includes a plurality of individual conductors, and the metal or alloy seals around the individual conductors.

16. The method according to claim 1, including the step of melting the metal or alloy to disassemble the cable splice.

17. The method according to claim 1, wherein the cable splice is covered in a insulation boot.

18. The method according to claim 1, wherein a drain port is provided in the closed chamber to enable the metal or alloy to be emptied from the chamber.

19. The method according to claim 1, wherein the metal or alloy is a bismuth alloy

20. The method according to claim 1, wherein the metal or alloy is a lead or a lead alloy

21. The method according to claim 1, wherein the melting point of the metal or alloy is selected depending on the anticipated well bore temperature.

22. A cable splice between a first electrical cable and a second first electrical cable together in a downhole environment, the first electrical cable including at least a first conductor, the second electrical cable including at least a second conductor, the cable splice formed by:
bringing the first conductor into electrical contact with the second conductor;
forming a closed chamber around the first electrical cable and a second first electrical cable; and
melting a low temperature metal or metal alloy and encapsulating the first electrical cable and a second first electrical cable in the penetrator body this metal or metal alloy.

23. A cable splicing apparatus configured to form a cable splice between a first electrical cable and a second first electrical cable together in a downhole environment, the first electrical cable including at least a first conductor, the second electrical cable including at least a second conductor, the cable splicing apparatus comfigured to carry out a cable splicing method that includes:
bringing the first conductor into electrical contact with the second conductor;
forming a closed chamber around the first electrical cable and a second first electrical cable; and
melting a low temperature metal or metal alloy and encapsulating the first electrical cable and a second first electrical cable in the penetrator body this metal or metal alloy.
